(19) United States
(12) Patent Application Publication
(10) Pub. No.: US 2008/0177793 A1
(43) Pub. Date: Jul. 24, 2008

(54) SYSTEM AND METHOD FOR USING KNOWN PATH DATA IN DELIVERING ENHANCED MULTIMEDIA CONTENT TO MOBILE DEVICES

(76) Inventors: Michael Epstein, Cambridge, MA (US); Matthew Hockenberry, Boston, MA (US); Aaron S. Freedman, Cambridge (GB); Ira J. Hochman, Cambridge, MA (US)

Correspondence Address: LAHIVE & COCKFIELD, LLP, ONE POST OFFICE SQUARE, BOSTON, MA, 02109-2127, US

(21) Appl. No.: 11/858,831

(22) Filed: Sep. 20, 2007

Related U.S. Application Data
(60) Provisional application No. 60/767,580, filed on Sep. 20, 2006.

(51) Int. Cl. G06F 17/30

(52) U.S. Cl. 707/104.1; 707/E17.001

(57) ABSTRACT

An authoring tool supporting the creation, editing and use of a “Mobile Media Documentary” (MMD) is discussed. An MMD is an interactive tour of physical and virtual locations that is accompanied by multimedia content mapped to spatial data for a known path. The multimedia content includes character-driven audio narrative supplemented by graphics, text, video and interactive content.

### RELATED APPLICATION

This application claims priority to, and the benefit of, co-pending U.S. Provisional Application No. 60/767580, filed on Sep. 20, 2006, for all subject matter common to both applications. The disclosure of the above-mentioned application is hereby incorporated by reference herein in its entirety.

### TECHNICAL FIELD

The embodiments of the present invention relates generally to multimedia presentations for mobile devices and more particularly to the use of known path data in delivering multimedia narrative content to mobile devices.

### BACKGROUND

Mobile media tours are media files that have been downloaded to a mobile device and played on the mobile device to assist a user in getting to know a place. The tours include walks around specific locations such as buildings and cities, and may provide overviews of attractions and histories of places. Data formats that may be used for such mobile media tours include mp3 files and podcast files. The users may download the files from the provider's website. Examples include audio guides offered in museums and guides for tourists geared to attractions or sites in a city. However, these files are not customizable and may be limited to a single type of media. Furthermore, they are not linked to spatial information of the user and are therefore not dynamic presentations of media content.

### BRIEF SUMMARY

The embodiments of the present invention support the creation, editing and use of a “Mobile Media Documentary” (MMD). An MMD is an interactive tour of physical and virtual locations that is accompanied by multimedia content mapped to spatial data. The multimedia content includes audio narrative supplemented by graphics, text video and interactive content. MMDs may be prepackaged and delivered to portable user devices prior to the user beginning a tour so that playback may be entirely local during a tour. Alternatively, the user device may include a network connection that allows the device to download aspects of the tour on an as-needed basis. An authoring tool, the Mobile Narrative System (MNS), enables the creation, editing, and delivery of these MMD tours. The Mobile Narrative System leverages the fact that users are following a known path while on the tour and uses the locative information of users to provide multimedia content associated with a user's location. The MNS includes intelligent delivery mechanisms for a variety of handheld devices and a number of modules designed to deliver a range of practical and experiential information to users through their own or others' mobile devices. The Mobile Narrative System also enables local multimedia producers to develop and maintain tours. The MNS incorporates site-specific media, face-to-face encounters, and location-based services that provide access to information about history and local life used to form an MMD.

In one embodiment, a Mobile Media Documentary tour authoring tool includes a data acquisition module for acquiring data and a graphical user interface. The graphical user interface enables the graphical selection of at least some of the acquired data and Mobile Media Documentary tour features. The authoring tool also includes an integrator module for integrating the graphically selected acquired data and features into a Mobile Media Documentary tour. The Mobile Media Documentary tour includes audio data, video data, graphical data, textual data, and interactive content associated with spatial data for a specified path. The authoring tool also includes a packaging module for packaging the Mobile Media Documentary tour into a portable data format that is compatible with multiple different types of user devices. Additionally, the authoring tool includes an installer module that customizes a Mobile Media Documentary tour that had been stored in the portable data format based on user device attributes. This customized Mobile Media Documentary tour is installed on a user device.

In another embodiment, a computer readable medium holds instructions for a Mobile Media Documentary tour that include instructions for a known path with corresponding spatial information. The medium also holds instructions for a plurality of multimedia elements including audio, video, text, still images and interactive content, wherein the plurality of multimedia elements are mapped to the spatial information. Additionally, the medium includes instructions for displaying a map of the known path to a user on a mobile device as a part of a Mobile Media Documentary tour. The map indicates the user's current location on the known path and the tour presents multimedia elements to the user based on the user's location without requiring a network connection.

In one embodiment, a method of interacting with a Mobile Media Documentary tour includes transferring the Mobile Media Documentary tour to a user device. The Mobile Media Documentary tour includes audio data, video data, graphic data, textual data, and interactive content associated with spatial data for a known path. The method also includes viewing the Mobile Media Documentary tour content in the user device and interacting with the Mobile Media Documentary tour.

### BRIEF DESCRIPTION OF THE DRAWINGS

FIG. 1 illustrates an exemplary environment suitable for creating and distributing Mobile Media Documentaries (MMDs);

FIG. 2 depicts exemplary components of the Mobile Narrative System (MNS) module;

FIG. 3 is a flow chart illustrating the use of an MMD authoring tool;

FIG. 4 illustrates exemplary components of a Tour Developers' System module;

FIG. 5 illustrates exemplary components of a Mobile Mementos module;

FIG. 6 is a flow chart illustrating a user's interaction with MMDs;

FIG. 7 illustrates an exemplary interface for a Mobile Narrative System; and

FIG. 8 illustrates an exemplary hand held device display an MMD.

### DETAILED DESCRIPTION

The embodiments of the present invention provide Mobile Media Documentaries (MMDs) that provide interactive multimedia content for mobile users. Conventional techniques for delivering content to mobile users suffer from drawbacks in that the conventional techniques delivers content in fixed formats and fail to use combinations of different types of content such as graphics, text and video accompanied by interactive features. Additionally, while the media in conventional tours may be informative for users, it makes little or no use of device mobility and location awareness. In contrast MMDs created, edited and used by the embodiments of the present invention provide integrated combinations of multimedia content associated with locative data so that a viewer of the MMD receives the most relevant data during the tour.

The embodiments of the present invention support the creation, editing and use of a “Mobile Media Documentary” (MMD). A mobile media documentary is media content experience that includes on character-driven audio narrative supplemented by video and interactive content. MMDs may be prepackaged and delivered to user devices prior to the user beginning a tour so that playback may be entirely local during a tour. Alternatively, the MMDs may be transferred to a user device on an as needed basis. A software authoring tool, referred to herein as a Mobile Narrative System (MNS), enables the creation, editing, and delivery of these MMD tours. The Mobile Narrative System leverages the fact that users are following a known path while on the tour. The Mobile Narrative System uses the locative information of users without necessarily relying on sensor technologies such as GPS and Cellular Triangulation. The system includes intelligent delivery mechanisms for a variety of handheld devices. A number of modules designed to deliver a range of practical and experiential information to travelers through their mobile devices are included in the MNS. The Mobile Narrative System also makes it easy for the local multimedia producers to develop and maintain tours for their locations. The MNS authoring tool incorporates site-specific media, face-to-face encounters, and location-based services that provide access to information about history and local life in forming an MMD.

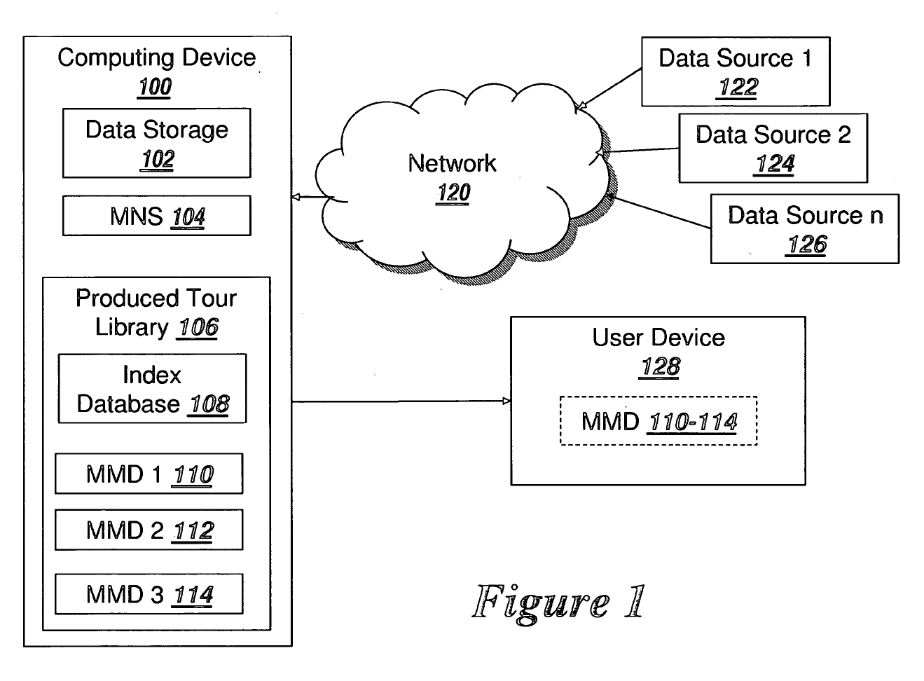

FIG. 1 depicts an exemplary environment for creating, editing and using an MMD. The MNS 104 gathers various types of data for an MMD tour from local and remote locations and saves the data in storage 102 on a computing device 100. The computing device 102 may be any computer system such as a workstation, desktop computer, server, laptop, handheld computer or other device that is capable of communication and that has sufficient processor power and memory capacity to support the operation of the MNS and perform the other operations described herein. The computing device 100 may include a network interface to the network 120. The network 120 may be a Local Area Network (LAN), Wide Area Network (WAN), the Internet or some other type of network through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface may be a FireWire interface, FlexRay interface, RS-232 interface and may include a built-in network adapter, network interface card, PCMCIA network card, card bus network adapter, wireless network adapter, USB network adapter, modem or any other device suitable for interfacing the computing device 100 to network 120.

The data can be gathered via the network 120 from various data sources 122, 124 and 126. The data may be video data, audio data, still image data, advertisement data, text, interactive content including interactive applications, and other forms of data. Data sources, 122, 124 and 126 may include commercial and non-commercial databases holding various types of content. The Mobile Narrative System 104 may be used by a tour author to access the data storage 102 and associate selected portions of the gathered media data with spatial data associated with physical or virtual locations on a known path as part of the process of creating an MMD 110, 112 and 114. The use of the MNS in creating the MMD is discussed further below.

The MMDs 110, 112 and 114 are stored in a device-independent manner in a portable data format that may be transformed into multiple different formats as needed. The MMDs 110, 112 and 114 include the media files integrated into the tour by the MNS 104 and at least one index file indexing the media files. The MMDs 110, 112 and 114 may be stored in a tour library 106. The library may also include an index database 108 that contains a list produced by the MNS that maps data with various known path tours. The data storage 102 and the produced tour library 106 may be local to the computing device 100, may be stored at a remote device or may be stored in a portable storage device such as a USB memory stick, a CD or similar device. It will be appreciated that data storage 102 and produced tour library 106 may also be stored in multiple locations. Once the MMD 110-114 is created, it may be downloaded to a user device 128. The download may also be realized through a carrier, such as a wireless connection carrier. The user device 128 may be a handheld device such as a cell phone, a personal data assistant (PDA), a blackberry® or an iPod®. The user device 128 may also be a laptop or a desktop, from which the MMD 110-114 may be subsequently transferred to a handheld device.

In one embodiment a locative system called “Mobile Path Anchoring” that is based on a known path model of spatial positioning provides locative anchoring for the content presented in Mobile Media Documentaries 110-114. The availability of sensor technologies such as GPS and Cellular Triangulation to the MMDs is limited and instead, the MMD relies on the constraints of the walking-tour domain. Content can be precisely targeted along the walking path, and any user-created content can be captured and geotagged for later sharing. The embodiments of the present invention create a flexible, user-controlled experience where the user closely follows a particular path over time. Accordingly, spatial determinations made by the MMD during the tour have an extremely low level of granularity and a high probability of accuracy.

The use of known path anchoring enables the MMD to offer spatially relevant services and advertisements during the tour narrative. It further allows capturing user created media that can be tagged and associated with the place on the tour they were captured (this is referred to herein as “geotagging”). The Mobile Narrative System 104 offsets conventional limitations of a fixed path tour by allowing users to control the length and path of their tours at initial tour creation, as well as to alter the tour path at key points placed throughout the walk, for example, at fixed or mobile way stations. Using the Mobile Path Anchoring system in the tour, spatial determination is made with regard to coordinate space, for example, using traditional latitude and longitude coordinates, 3D coordinates and other coordinates. The system also organizes this information within a more general place-based model that is useful for capturing user-generated trip memorabilia. This allows mobile tour applications to combine the insight of a human tour guide, the narrative of a documentary, and the utility of a phone book. The advertising framework relies on known path information to present situated locative information. This includes practical information (restaurant, shopping, or outside entertainment availability), general services (ATMs, Emergency, Transportation), advertising and alike.

MMDs 110-114 built with the Mobile Narrative System 104 may use audio instructions for way finding that are incorporated into the audio presentation that serves as the center of the tour. Automobile navigation systems already show that locative aware audio directions are highly effective at way finding. Supplementing the audio instructions for the user viewing the MMD is a series of street-level photos. Street level photos may be specifically captured or pulled from existing repositories. The photos allow the user to “see what he or she should be looking at” throughout the tour. To offer higher level viewpoints of the experience, the system offers a view of overall progression and a map view similarly drawn from existing sources. The map view shows the user progress and upcoming spatial points.

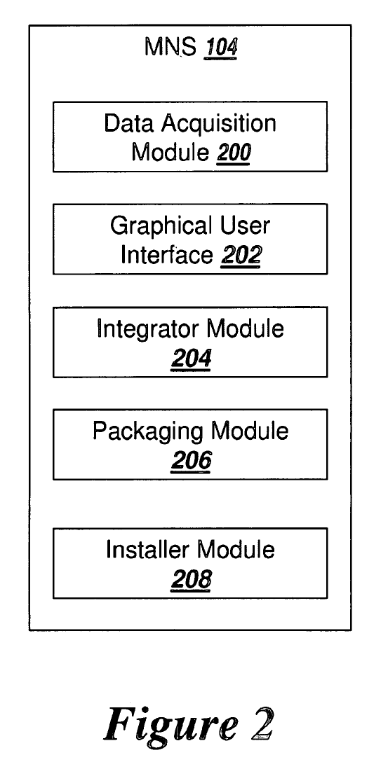

The authoring tool used to create an MMD, the Mobile Narrative System 104, includes a number of software modules that are used to create and deliver MMDs 110-114 to a user device 128. FIG. 2 illustrates various components of an exemplary Mobile Narrative System 104. The modules utilized by the MNS 104 may include a data acquisition module 200, a graphical user interface 202, an integrator module 204, a packaging module 206, a content management module 208 and an installer module 210.

The data acquisition module 200 may retrieve data from a number of local and remote sources. The data acquisition module 200 may gather spatial information from a number of databases, including commercial databases, through open web services or other Application Program Interfaces (APIs), including but not limited to SOAP, REST, RPC and AJAX. Mobile Narrative System 104 gathers and incorporates this information with local databases, such as advertisements associated with spatial points, before it is packaged for the user device 128. The spatial information that a known path location system used in the MMDs relies on is captured at tour creation. When a user goes to purchase a tour, they are offered the possibility of customizing the path information to some degree. Once a successful tour path (or series of paths) is created, the MNS 104 queries the providers of spatial information (high level providers such as Google Maps, Yahoo Maps etc . . . or low level providers such as Tele Atlas® and NavTeq®, depending on the commercial and technical circumstances) and gathers the relevant map information, list of services (restaurants, cafes, restrooms, ATMs, etc . . . ) and spatial metadata (latitude and longitude information, place regions, and so on) and, from open web services, or other APIs, incorporates it, based upon the intended target platform, into the tour package for download or organizes a portion of the content for dynamic download during the tour experience. In the former case, this ensures that once the user has purchased the tour, all of the relevant content and spatial information is available locally without the need for a data connection. In the latter case, this allows support of devices that cannot accommodate storing the entire tour data or for reasons of experience, cost or dynamism, may prefer to acquire data in a just-in-time fashion.

Graphical user interface 202 allows a tour author to map a route and create media sequences from the previously acquired data. The graphical user interface 202 allows the tour author to define an associative correlation between the multimedia data and the mapped route, as well as other practical services described herein. It also allows the user to specify and manipulate the map representation of the route that will be included in the MMD. The graphical user interface 202 permits the saving of preferences and work (e.g. routes, media, media sequences, correlations) into a portable data format (referred to herein as “Mobile Media Authoring Project” or “MMAP”). It also permits loading of previous preferences and work by reading from the MMAP format.

An integrator module 204 receives the tour author's preferences through the graphical user interface 202 and associates the selected data with the tour route to create an MMD. In addition to the multimedia files, including the map representation, an index file indicating how the multimedia content maps to the spatial data from the tour route is also created. In one implementation, the index file is an XML file. Also bundled with the tour is a media presentation module that is used on the target device to present the MMD to a user. The Mobile Media Presenter (MMP) module is a light runtime module that targets large mobile platforms such as FlashLite and J2ME. MMP provides an overview and access to media elements, user interface and a set of automatically generated maps. MMP may be viewed as a skeletal loader application for various media, such as audio, video, text, still image, etc. MMP functions as a technical specification for organizing certain types of media content, describing appropriate interactions, offering associated user interface components for those interactions, and accessing standard mobile technology features to support those interactions. The MMP may be organized as an XML or textual schema that provides a listing of media elements (such as video, audio, interactive content, and textual information). The textual schema includes information about the length and position of content within the described world. This information is either a precise coordinate listing (latitude and longitude, etc.) or a general place-based association with discrete spatial objects such as buildings, parks, streets or alike. The schema describes the nature of the content for indexing and playback as well as providing meta-information descriptive of system interactions during the presentation of the content.

A packaging module 206 is used to combine the created tour into a device-independent portable data format. The MMAP format is a permanent portable storage format for holding information needed to create a tour experience on supported target devices of different types. The information stored in MMAP includes, without limitation, route information, points of interest, media (whether used or not), media sequences, interaction behavior (e.g. quizzes, pauses, menus, optional detail content, etc), tour style preferences, intended target devices, authoring preferences, and the correlation between route and media presentation. The MMAP may be implemented as the media files included in a tour project and an XML file or database entries that index the media files and otherwise defines the tour. The MMAP describes the tour in a format that is intended to be target device independent. The MMAP is separately transformed into a format appropriate to specific target devices.

An installer module 208 is used by the MNS to transform the packaged tour (the MMAP module) based on the attributes of the target user device. The installer module 208 performs the format conversion and packaging of MMDs for supported target devices. The installer module 208 may be provided as a hosted service to users of the MNS. In one embodiment, tour authors using the hosted service may grant to an entity providing the service a license to distribute, display, modify (ads) and sell publicly released tours and share revenue with the producer/author of the tour. In another embodiment, enterprise customers may purchase licenses to use one or more installer modules privately in-house and retain full rights to their tours.

The installer module 208 is a collection of services that can be provided in total or in a subset on a single server or across several servers. In one embodiment, the installer module may be implemented in Java. The installer module 208 provides a number of capabilities. The installer module 208 may create a device specific representation of a tour. A tour project index (as an XML file) and associated multimedia content (converted to the MMAP format) may be passed to it with the specifics of the desired target(s). The installer module 210 may then process the information as necessary, creating the MMD XML representation, converting and encoding multimedia content, and arranging the file structures. It will be appreciated that other formats of the MMD may also be created including those utilizing iTunes® mp3 format, WAP/WML, or other vendor's playback software (such as uLocate's WHERE® system). Additionally, depending upon the configuration of the services, the installer module 208 may take the target result and return it to the author, store it in a repository, send it to another user or system, or perform some combination of these.

The installer module 208 may also provide, to users or systems, an indexing, search and retrieval interface on a repository holding source content used to create an MMD. The repository search and the target generation capabilities can be bundled together in a single installer module or unbundled and provided separately or on a distributed fashion across several servers.

The installer module 208 may also be integrated with Ad Server technology to provide context relative advertising that can be bundled within a particular tour or externally provided. This capability integrates with the repository search and retrieval functions of the installer module 208 and the repository of the produced tours.

The installer module 208 can communicate with the user device 128 and packs necessary materials, specifically the MMP and associated MMDs 110-114. The installer module 208 selects the best transfer method for content. Transfer methods include Bluetooth, flash memory, USB, download via SMS or Brew, and other mobile device standards, based on device capabilities and the user system status. The first time a user purchases a tour, the system installs a lightweight mobile installer and a skeletal framework for playing tours on the user device. From this point forward, purchased tours can be automatically packed and unpacked by downloading a new tour from the website.

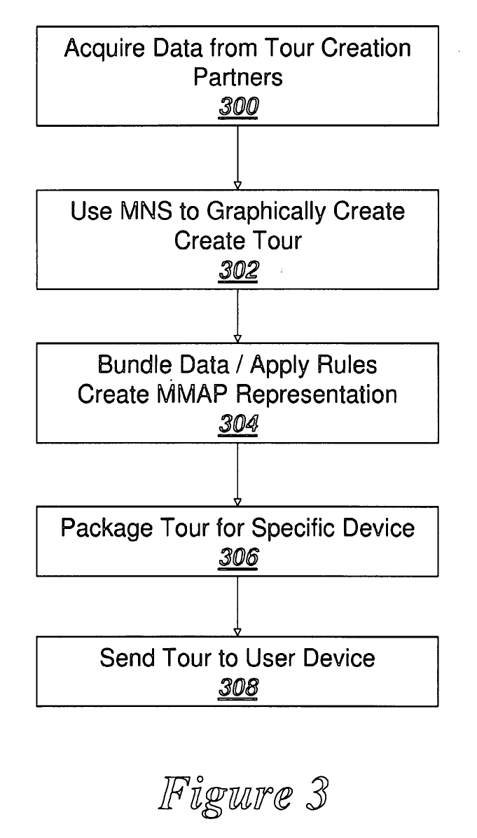

The overall sequence of events for creation and use of an MMD tour is depicted in FIG. 3 which illustrates a flowchart of events managed by the MNS 104. Once the data for a tour is acquired from tour creation partners (step 300), the MNS provides a user interface that allows a tour author to graphically create the tour by applying the MMAP to a predetermined known path, (step 302). The Mobile Narrative System 104 puts the data in a device independent format. This is accomplished by bundling the data and applying rules to the data. The end product is the tour transformed into the portable storage format (MMAP), (step 304). The tour may then be packaged for a specific device, such as a mobile phone, iPod®, a blackberry etc., (step 306) and sent to the corresponding user device.

The authoring tool (MNS) 104 may also include a Tour Developers' System module 402. The tour developers' system module 402 is a web infrastructure that enables content producers to organize and deliver the mobile narratives to the mobile platform to make them available to the user. Tour Developers' System module 402 is an interface that offers various levels of interaction with media depending on the nature of the access. The Tour Developers' System module 402 is focused on the presentation of media content that is structured in time and/or in place and stored in the storage 102. The Tour Developers' System module 402 may include a database description of the content, a web based mechanism for uploading necessary media content and annotating it with necessary information, and a set of interaction controls that allow the manipulation of this information. The interaction controls may be constructed as AJAX or Flash platform widgets that present the media content as organized by time and/or space. Editing and content creation tools enable a user to make additional annotations, trim sections of content, reorganize and replace pieces of content, and perform basic presentation adjustments in real time. Changes that are created by content creation tools may appear as newly edited or created in an editor interface. Notices and suggestions offered by the editing tools may also appear in the interface. When the content has been sufficiently edited, the same interface reveals the final MMD 110-114 to the user and enables instant download. The interface revealed to the user appears essentially the same, albeit with the removal of most editing capabilities.

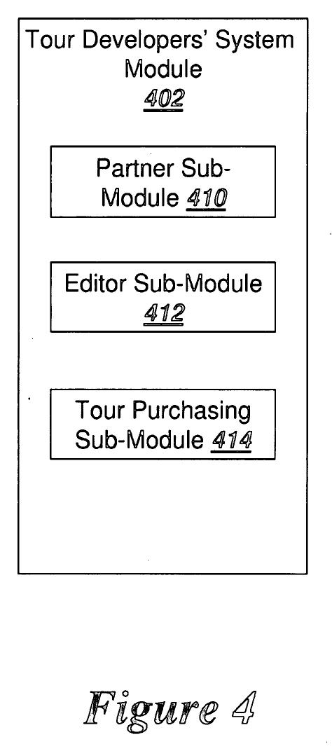

As illustrated in FIG. 4, the Tour Developers' System module 402 may include three sub-modules: a partner sub-module 410, an editor sub-module 412 and a tour purchasing sub-module 414.

Partner sub-module 414 includes information about tour creation partners, contact points and partner tools. It displays the partner information and allows the sharing of primary content among a partner and an editor by enabling the uploading of partner materials to create the tour. Partner sub-module 414 may retrieve partner information and create statistical summaries of partner created content.

Editor sub-module 412 allows reviewing and editing of primary content submitted by partners. It supports a tour-centric vision of editing. Editor sub-module 412 allows accepting/rejecting, reorganizing, clipping and editing pieces of content for a tour. It also allows notes suggesting changes to the fundamental focus of content.

Once the tour is created, a tour purchasing sub-module 414 may allow the tour to be instantly purchased by a user. The tour purchasing sub-module 414 may be a webpage that presents tour map components and allows customization of the tour. The user may then purchase the tour. Tour purchasing sub-module 414 utilizes the tour map component for interactions and spatial display. It may display a calendar-like schedule to prepare one-day or multiple-day tours. It also presents associated costs and purchasing options.

The Mobile Narrative System 104 may also include a mementos module 500 that may be used to supplement the regular multimedia enhanced narrative experience of the tours. Through the mementos module 500, picture and video data captured through a camera phone during a tour may be geotagged to the location where the media is taken. The geotagged media may then be integrated into the user's free online geo-photo album or may be used to generate a tour variant or new tour using the aforementioned tools. The geo-photo album may be shared and/or combined with other user's albums. The mementos module 500 makes use of spatial information associated with tours. Additional media types, such as audio capture and text entry may be incorporated through the associated mobile device input mechanism.

For example, in one embodiment, while on a tour, the user may activate the mementos module by selecting a “memento mode” using the device controller. An exit time (from the tour) and geo-code may be recorded at the point of user request. The geocode can come from the Known-Path algorithm, a sensor technology or both. An asset collection module is launched (this can be a part of the MMP, can be a separate application or can be an application built into the device). Photos, video or audio may be collected within the memento module 500. In some implementations, sensor-based location data may also be collected during the asset collection. The user may use the device's controller to indicate completion and return to the same point in the tour. Optionally, the sensor-based geo-data collected in the memento module can be used to determine the point where the user resumes the tour. The completion time and final geocode may also be recorded at the point of return to the tour

An upload module may assist with the transfer of photos and their associated time and geo-data from the phone to a photo-album in the exemplary form of a map-oriented website. The upload module can be written in J2ME, Python or other language appropriate to the device upon which it runs. The data can be transferred via a web service or other API. The data can be transferred during the tour or after. Transmission may occur over the network or via direct link to a computer.

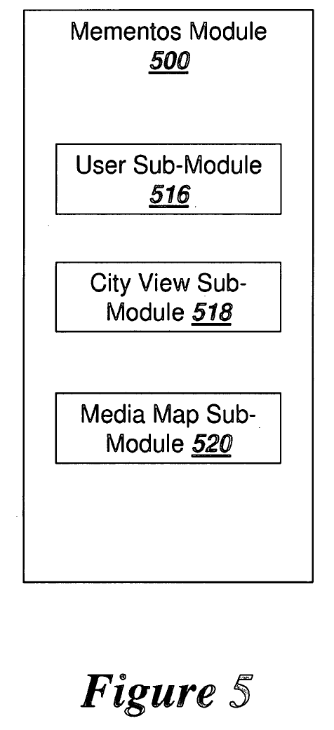

As illustrated in FIG. 5, in one embodiment, mementos module 204 includes sub-modules such as User sub-module 516, City View sub-module 518 and Media Map sub-module 520. Users may easily switch between these sub-modules.

User sub-module 516 may store user purchase records of recent and previously purchased tours. It provides a staging area for packing tours. User sub-module 516 retrieves user information, such as purchase history, user preferences and promotions; and device information, such as language and appropriate packing format. User sub-module 516 may also display changes or updates to the previous purchases. Limited versions of this information may also be made available to other users.

City View sub-module 518 may utilize the media map sub-module 520 to show various levels of distance as the user explores the range of possible options. It gives a visual drilldown of available geospatial information. City View 518 may also display random highlights from the partner content or the user created content.

Media map sub-module 520 may create a map that displays regions of space and information on these regions. Media map 520 may plot markers such as audio, video, text, still image markers and/or paths with user interaction and control. Media map 520 may also set region masks to allow the perception of a constrained region of space for displayed data, such a neighborhood or a metropolitan area.

In another embodiment, a mobile version of the MNS may also be provided to the mobile device so that a user may create a tour while in the field. The mobile version of the MNS is primarily intended for use with a mobile device with recording capabilities (audio, visuals or both) and a location sensing system. The location sensing system can be integrated with the recording device or may be separate and synchronized via timestamp. With the mobile version of the MNS, a user in the field can collect picture and video assets, can record audio and can annotate pictures and video with audio. The geo-tag and time data for each asset is recorded and associated with the asset. The collected data can then be uploaded into the MNS (in the same fashion as mobile mementos) and the MNS reconstructs the tour in the MMAP format, allows the user to adjust, refine, enhances and publishes the tour using the features of the MNS. It is also possible for the MNS to convert the audio annotations into written notes usable in captioning within the MMP using technology such as speech recognition.

Mobile Narrative System 104 may additionally include a tour notification and marketing system module. A tour notification and marketing system offers promotions and practical information throughout the tour experience. The MNS 104 may also include a workflow component which includes features for team development, production workflow, version control and coordination of multiple projects.

The authoring tool may include additional user enhancements to further customize tour length and/or content. Modules may be downloaded dynamically from a network, such as the Internet or carrier-based services. An emergency warning system and interactive quizzes and other games may be included as part of the tour. Additionally, means of interacting with friends, such as monitoring friends' progress and/or the ability to exchange photos during the tour may also be provided.

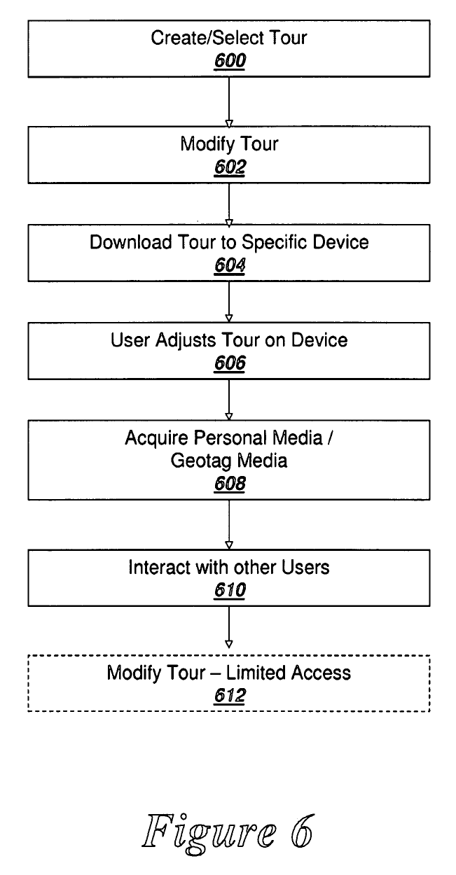

FIG. 6 illustrates a flowchart of events managed by the user. The user may select or create a tour, (step 600). The user is given some freedom to customize the tour, such as add or remove points of interest, modify the length, change the language, etc., (step 602). The user then downloads the tour to a specific device, (step 604). The user can then perform a smaller set of adjustments to the tour on the device (step 606). The user may acquire personal media during the tour, such as still images, video, audio and geotag this media to the specific location where the media is created, (step 608). The user may interact with other users, such as by sharing media or monitoring another user's progress, (step 610). Optionally, during the tour, the user may have limited access to modify certain aspects of the tour through the use of waypoints and other mechanisms (step 612).

Thus, the spatial information that a known path location system relies on is captured at tour creation. When the user downloads a tour, they are offered the possibility of customizing the path information to some degree. Once a successful tour path (or series of paths) is created, the Mobile Narrative System 104 queries the providers of spatial information (high level providers such as Google Maps®, Yahoo Maps®, etc. or low level providers such as Tele Atlas® and NavTeq®, depending on the commercial and technical circumstances) and gathers the relevant map information, list of services (restaurants, cafes, restrooms, ATMs, etc.) and spatial metadata (latitude and longitude information, place regions, and so on). Mobile Narrative System 104 then incorporates the gathered data from open web services into the tour package (MDD 110-114) for download. As such, once the user has downloaded the tour, all of the relevant content and spatial information is available locally without the need for a data connection. This allows the MMD tour to take place without requiring the use of GPS (global positioning satellite) data. This provides an added benefit as event though the GPS and other sensor technologies are powerful, they suffer strong limitations in certain key areas, such as indoor areas and dense urban corridors. It will be appreciated that in other embodiments however, the MMD tours described herein may also leverage GPS and sensor technology when available and supported by the user's hardware without departing from the scope of the present invention.

The user may also be presented with the option to customize the path of the narrative experience at several points. This is initially done at tour download. Customization is also available at certain points, called waypoints, throughout the tour. These waypoints are accessible at areas of the tour to offer additional timely content and/or to allow the user to alter or add to the path of the narrative experience. This additional content may reach the mobile device via Bluetooth® technology or similar mechanism. Accordingly, the waypoints can function as mobile sync points. This capability is available to any user who has a data connection. There may be additional cost associated with downloading additional content. These waypoints more accurately mirror the real world idea of forks or signs, although virtual and conforming to a more limited area of the transportation structure.

Waypoints allow alterations to the user tour experience (selection of new paths or changes to existing paths) as well as upload of user captured media. Exemplary embodiments incorporate mechanisms that allow user control over tour playback and relevant stop points to ensure that the narrative is tightly joined to the spatial path. This includes automatic adjustments to the pace of the audio presentation, the inclusion of video or interactive stop points and a set of user controls for playback. To automatically control pacing, segments of the tour content (such as audio segments) are tagged with their semantic importance with regard to overall and immediate structure and content. Accordingly, the system may drop unnecessary segments because of time constraints, or perceived lack of user interest. In one embodiment, a user profile system, for example as an XML micro format, is included to adjust tour pacing and other features based on user description, past performance, and comparison to other user profiles. This adjustment may be done by using existing statistical learning to facilitate the matching process.

Components in the mobile devices allow push content to be displayed at relevant media points as well as a method for quickly and easily querying the local database for spatial information. The component may be an XML based local database format that is broken down categorically for efficient seek and parsing by the Mobile Media Presenter. Push content is stored in a separate listing, to be displayed upon certain locative points in the tour progression. This allows the user to gather information about things such as restaurants, cafes, etc. to visit during the path experience.

Map presentation throughout the tour experience indicates the perceived user location and offers directive information to the result of user queries or push information throughout the tour. The map image can be automatically generated or customized by the tour author via the MNS. The map route data is captured from providers with web services, compressed, and packaged with the additional content before being transferred to the mobile device. The MMP maps the geo-tagged route to the coordinate system of the provided map image to provide a scaled representation of the route and real time representation of the user location along that route during the tour. Media capture applications allow the user to capture media during the tour, geotag it with necessary spatial information, and group these photos for aggregation at way points or at tour completion. Some devices may require the construction of a Java (J2ME) stub that is launched by the Mobile Media Presenter. The geotagging may be based purely on latitude and longitude points. Geotagging is displayed at a rich web area for sharing and aggregating media by broader place notations.

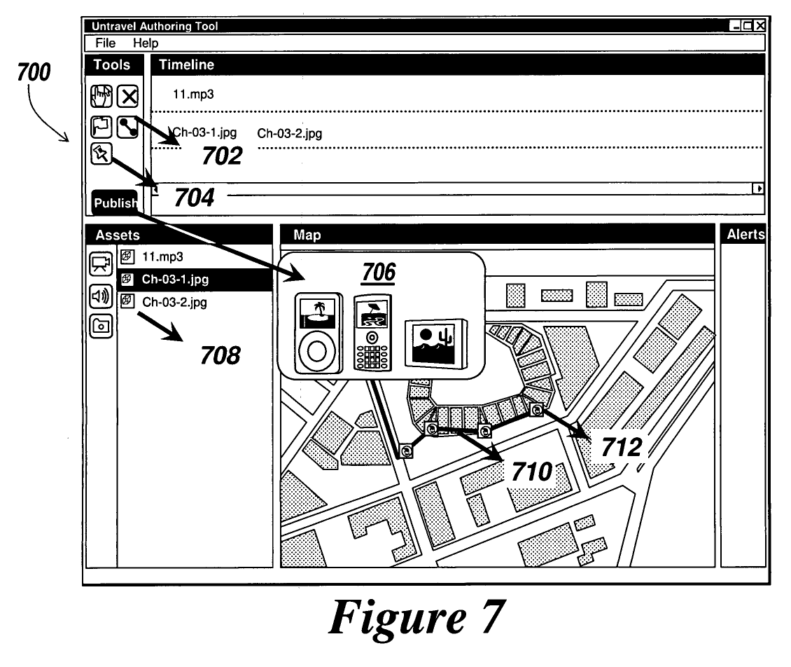

FIG. 7 illustrates an exemplary Mobile Narrative System interface 700. The types of information MNS interface 700 presents may be requested by the user or served passively to the user. For example, the user, using a “create way points” button 704 may create way points 712 designating the places that the user would like to see during his or her tour, and then using a “connect points” button 702 to create a path 710. The user may also create a query for points of interest, such as nearby Italian Restaurants. The information, in the form of advertisements, notifications, and points of interaction may also be served to the user. Because the tour system constructs a path 710 for the user to follow, given a successful use, the system is able to determine precisely (within several meters) where the user is. A successful use is motivated by several key factors that include the user's control over the progression of the tour (pause, rewind, and so on) and built in stop points on the tour (to watch a video, or interact at a specific location).

The MNS 104 grants a user maximum flexibility in developing the tour, by allowing incremental development of segments of the tour and easy adjustment of any subsection of the tour without disrupting the association between media and geo-coded route outside the edited segment. Media elements can be added in batch or on demand, way points (points of interest) can be added or moved at any time, paths between points of interest can be added, removed or relocated as needed. Media can be added to existing paths and waypoints or added to newly created paths and waypoints. This allows a tour creator to better develop smaller portions of the tour and then to expand these segments by extending the segments or inserting additional segments as the narrative is better understood.

In one embodiment, the sequencing of authoring steps requires that a media element must be introduced to the tour project before it can be used. A path element (waypoint or path) must exist before media can be associated with the element. Additionally, the waypoints must exist before a path can connect them. It will be appreciated that the sequencing of authoring steps is illustrative and that other sequences of authoring a tour may also be included within the scope of the present invention.

The MNS defines a richer concept of media than the general industry. In the MNS, media includes: images, video, audio, text and interactive content (games, quizzes, explorations, etc.), tour branches, chapter marks/jump points, pause points, advertising frames, brand (logo) frames, informational frames and sources for advertising.

The media types of Advertising frames, Brand (logo) frames, and Informational frames allow the placement of placeholders to accept dynamically supplied media such as from an associated database or from a sequence or dictionary of available elements compatible with the media type specified for the frame (audio/image/video). The dynamic media elements can be bundled with the tour or supplied over the network or at electronically enhanced waypoints during tours. Frames can have associated parameters that filter and control timing/duration of media insertion into the frame. Examples of filter parameters include topical information such as business information, food related information, entertainment related information, event information, cost of service information, maximum distance from location, etc. This parameter list may be dynamically generated from the data sources available to the user. Examples of parameters may include minimum time on-screen, if acknowledgement is required from user (for example to accept/display a coupon), whether the element can be skipped over by user, etc.

The MNS 104 uses the route and media information to pre-calculate the planned walking time and waiting time for paths and waypoints respectively. For example, in one implementation an expected travel speed is assumed(which can be selectively changed by the user), uses the geocode data of the path to calculate the length of path and then computes the corresponding time to walk that distance. This becomes the default travel duration for the path. An additional time component is added to this to represent time needed for apprehending directions. Media is dragged into the MNS geocoded-route in a fashion (different color zones) that indicates its intent (directional information or narrative while traveling). The total expected travel time is the sum of the duration of directional media plus the narrative time, where the narrative time is the greater of the computed duration from the path length or the net duration of the narrative media on that timeline. Waypoints have a wait time that is computed directly from the duration of the media associated with that waypoint. The user may override the computed value manually for any one or more paths or waypoints. The user may also provide alternate algorithms for performing these calculations through an add-in or plug-in style architecture.

In other embodiments, further refinement of these calculated times, such as taking into consideration surface material, mode of travel, and other factors is performed. The above algorithm allows the system to compute the total tour expected duration as well as the specific timecodes/geo-coordinate relationship for any single media element along the tour.

The design of the data structures correlates media elements to paths or waypoints. When path elements are selected, the focus of the media timelines is automatically narrowed to match the timeframe for the selected path elements and editing can be performed within this timeframe. Correspondingly, this means one or more paths, waypoints and their respective media can be edited without disruption to the completed media placement on the rest of the route. The exception to this is if the net duration is changed for the modified paths/waypoints, then the media elements are time adjusted to match the delta from the original pre-edited path. For example, if a waypoint with two paths connected to the waypoint is selected and the waypoint moved such that the paths are lengthened, then the computed travel time for those paths should increase. If this increase exceeds the narrative media duration for those paths, then the travel time is increased for the paths and the net increase automatically ripples through the media located later in the route. Subsequent media then have a planned start time that was increased by the preceding net increase in the path duration.

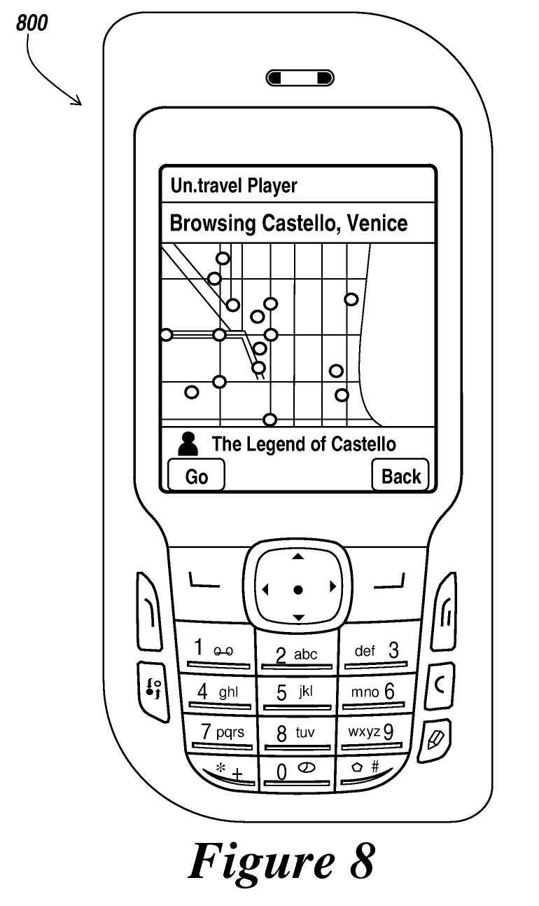

The user may have more than one tour 704 on his/her profile. The user may select the tour of interest and download it to a specific device 708. FIG. 8 illustrates a cell phone 800 displaying an MMD.

Although the present invention is described with reference to the exemplary embodiment illustrated in the figures, it should be understood that many alternative forms can embody the present invention. One of ordinary skill in the art will additionally appreciate different ways to alter the parameters of the embodiment disclosed, such as the content of the documentaries or various modules of the software, in a manner still in keeping with the spirit and scope of the present invention. It should be appreciated that the various software modules described separately herein may be implemented as one or more separate applications, plug-ins, processes or other forms of executing software code providing the functionality described herein. Although described separately, it will be appreciated that the functionality of the modules may also be divided and or combined in a number of different combinations of different executable software processes that collectively provide the functionality described herein without departing from the scope of the present invention.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved.

We claim:

1. A computing device implemented Mobile Media Documentary tour authoring tool, comprising:
a data acquisition module for acquiring data;
a graphical user interface, the graphical user interface enabling the graphical selection of at least some of the acquired data and Mobile Media Documentary tour features;
an integrator module for integrating the graphically selected acquired data and features into a Mobile Media Documentary tour, the Mobile Media Documentary tour including audio data, video data, graphical data, textual data, and interactive content associated with spatial data for a known path;
a packaging module for packaging the Mobile Media Documentary tour into a portable data format compatible with a plurality of different types of user devices; and
an installer module that customizes a Mobile Media Documentary tour stored in the portable data format, the customizing based on user device attributes, the customized Mobile Media Documentary tour installed on a user device following customization.

2. The authoring tool of claim 1 wherein the data acquisition module accesses one of a commercial and non-commercial database to acquire data.

3. The authoring tool of claim 1 wherein the data comprises one or more of a map, a practical information listing, a general service listing, an interactive application or advertising.

4. The authoring tool of claim 1 wherein the integrator module integrates acquired data based on a user input.

5. The authoring tool of claim 1 wherein the Mobile Media Documentary tour links points of interest via a path on a displayed map, the path and said points of interest associated with an interactive multimedia narrative.

6. The authoring tool of claim 1 wherein the portable data format is user device-independent.

7. The authoring tool of claim 1 wherein the integrator module integrates multimedia data with spatial data to create the Mobile Media Documentary tour.

8. The authoring tool of claim 1 wherein the graphical user interface enables one of a tour author and user to add or delete data to/from the Mobile Media Documentary tour.

9. The authoring tool of claim 1 wherein the graphical user interface enables the Mobile Media Documentary tour to be created over a network.

10. A computer readable medium holding instructions for a Mobile Media Documentary tour, the medium comprising:
instructions for a known path with corresponding spatial information;
instructions for a plurality of multimedia elements including audio, video, text, still images and interactive content, wherein the plurality of multimedia elements are mapped to the spatial information; and
instructions for displaying a map of the known path to a user on a mobile device as a part of a Mobile Media Documentary tour, the map indicating the users current location on said known path, wherein the tour presents the one or more multimedia elements to the user based on the user's location without requiring a network connection.

11. The medium of claim 10 wherein the medium further comprises:
instructions for automatically pausing the presentation of multimedia elements based on the users location on the known path.

12. The medium of claim 10, further comprising:
instructions for receiving a user command to pause, rewind or fast forward the Mobile Media Documentary tour.

13. The medium of claim 10 further comprising:
instructions for receiving user acquired multimedia, wherein the user acquired multimedia is geotagged with the spatial information.

14. The medium of claim 10 wherein the Mobile Media Documentary tour is compatible with one or more user devices.

15. The medium of claim 10, wherein the Mobile Media Documentary tour is customizable with additional content at a designated location during the tour.

16. The medium of claim 10, wherein the additional content is added to the Mobile Media Documentary tour via a network connection.

17. The medium of claim 10 wherein at least a portion of the map is retrieved from one of a commercial and non-commercial database.

18. The medium of claim 10, wherein the one or more multimedia elements are one or more of an practical information listing, a general service listing, an interactive application or advertising.

19. The medium of claim 10, wherein the Mobile Media Documentary tour is stored on a remote server and downloaded to the user device.

20. The medium of claim 10, further comprising:
instructions for integrating one or more interactive applications into the Mobile Media Documentary tour, wherein the one or more interactive applications comprise a game or a quiz.

21. A method of interacting with a Mobile Media Documentary tour, the method comprising:
transferring the Mobile Media Documentary tour to a user device, wherein the Mobile Media Documentary tour comprises audio data, video data, graphic data, textual data, and interactive content associated with spatial data for a known path;
viewing the Mobile Media Documentary tour content in the user device;
interacting with the Mobile Media Documentary tour.

22. The method of claim 21, further comprising:
modifying the Mobile Media Documentary tour.

23. The method of claim 22, wherein interacting comprises geotagging newly acquired media with locations of the Mobile Media Documentary tour.

24. A computer readable medium holding instructions for a Mobile Media Documentary tour, the medium comprising:
instructions for a known path with corresponding spatial information;
instructions for receiving from a user following said known path a request to geotag at least one media element to a specified location on said known path;
instructions for geotagging the at least one multimedia element by associating the at least one media element with spatial data corresponding to the specified location;
instructions for receiving graphic indications of a second known path from a user, the second known path associated with corresponding spatial information and including a plurality of multimedia elements mapped to the spatial information for the second known path, the plurality of multimedia elements including audio, video, text, still images and interactive content, and the at least one geotagged media element; and
instructions for displaying a map of the second known path to a user on a mobile device as a part of a Mobile Media Documentary tour, the map indicating the users current location on said known path, wherein the tour presents the one or more multimedia elements to the user based on the user's location without requiring a network connection.
